(19) United States
(12) Patent Application Publication
(10) Pub. No.: US 2017/0068753 A1
(43) Pub. Date: Mar. 9, 2017

(54) Self Equivalence in Hardware Designs

(71) Applicants: Akram Baransi, Nazareth (IL); Michael Zajac, Midland, MI (US); Zaher Andraus, San Jose, CA (US)

(72) Inventors: Akram Baransi, Nazareth (IL); Michael Zajac, Midland, MI (US); Zaher Andraus, San Jose, CA (US)

(21) Appl. No.: 15/256,185

(22) Filed: Sep. 2, 2016

Related U.S. Application Data
(60) Provisional application No. 62/215,087, filed on Sep. 7, 2015.

(51) Int. Cl. G06F 17/50

(52) U.S. Cl. CPC G06F 17/504

(57) ABSTRACT

A method for verification of hardware uses self-equivalence to leverage automated abstractions where data path elements are identical in two designs. Equivalence is used between a qualified design and an independent reference.

### BACKGROUND

Integrated circuits are increasingly complex. To verify a hardware design will act as intended and will not generate unintended or unanticipated results requires increasing sophistication in verification and diagnostic schemes.

### BRIEF DESCRIPTION OF THE DRAWINGS

FIG. 1 is a simplified diagram of design used to illustrate different self-equivalence criteria.

FIG. 2 is a general framework diagram.

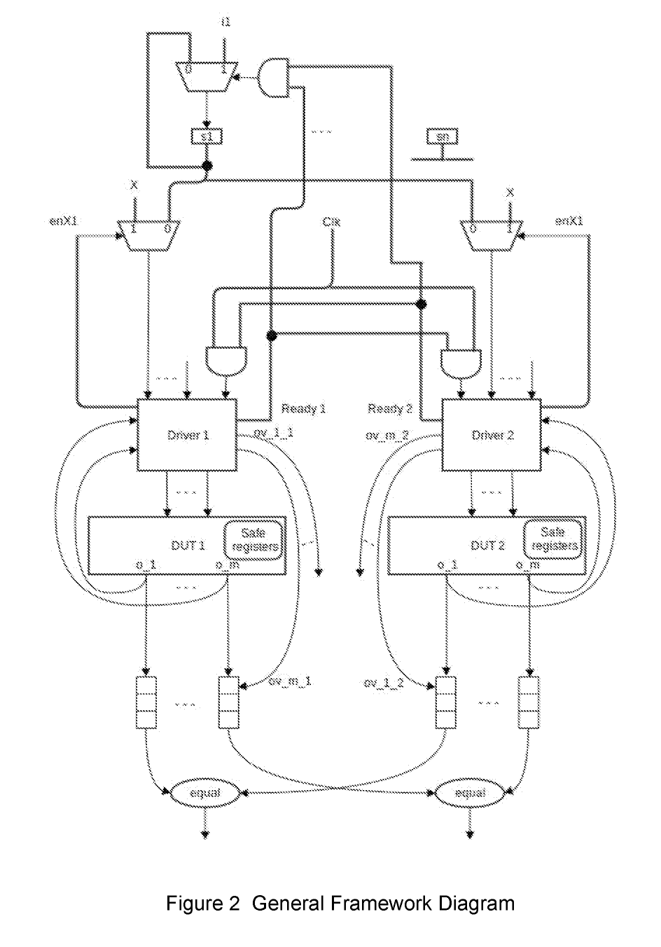

### DETAILED DESCRIPTION

### 1 INTRODUCTION

This document illustrates applications of self-equivalence for hardware verification, and showcases their utility in verifying, diagnosing, and improving design logic for computational systems. The first section includes definition son design and the generic class of self-equivalence criteria. The next section enumerates and explains concrete refinements of this class, and how it can be used to formulate desired behavior. The following section explain show these types of criteria can be leveraged in diagnosis, verification closure, and optimization of designs.

### 2 DEFINITIONS

A hardware design can be described as a tuple [symbol] V, INIT, Trans [symbol] . Where V=I U SU U, and I is the set of input variables, S is the set of state-holding variables, and C is the set of intermediate combinational variables. Each variable is a vector of 1-bit components, and each can take the value of 0 and 1. Thus, the valuation of an n-bit variable belongs to {0, 1}ⁿ.

Let S, C and I denote the sets of all possible valuations of S, C and I respectively INIT is a subset of S representing the group of initial states. Trans: S×I→S×C is a transition function such that (s′, c)=Trans (s, in) where s, in and c are the valuations of S, I and C respectively at the current time frame, and s′ is the valuation of S at the next time frame.

Let M= [symbol] V, INIT, Trans [symbol] be a hardware design. Let (s₁, . . . , sₙ_{ₛ}), (c₁, . . . , cₙ_{_{c}}) and (i₁, . . . , iₙ_{_{I}}) denote the elements of S, C and I respectively. Let projₛ (s, j) return the valuation of sⱼ under s.

In other words s= [symbol] projₛ(s, 1), . . . , projₛ(s, nₛ) [symbol] . Let proj_{c} and proj_{I} be defined similarly. Let val_{M} (s, in, v) denote the valuation of the variable v, given that the valuation of S is s, and the valuation of I is in. val_{M} is computed using the proj and Trans functions. Formally,

$${val}_{M} ( s , in , v ) = \{ \begin{matrix}{proj}_{s} ( s , j ) ; & v = {s}_{j} \\ {proj}_{I} ( in , j ) ; & v = {i}_{j} \\ {proj}_{C} ( c , j ) ; & v = {c}_{j} , where ( {s}^{′} , c ) = Trans ( s , in )\end{matrix}$$

Given that, let val_{M}^{k} be a generalization of val that takes into account the time frames of the design. Formally, val_{M}^{k} is defined recursively as follows:

val_{M}⁰(s, in, v)=val_{M}(s, in, v)

val_{M}^{k}(s, in₁, in₂, . . . , in_{K+1}, v)=val_{M}^{K-1}(s′, in₂, . . . , inₖ₊₁, v); where(s′, c)=Trans(s, in₁)

In words, val_{M}^{k}(s, in₁, in₂, . . . , inₖ₊₁, v) is the valuation of the variable v at the current time frame, given that the design started at the valuation s of S, got the inputs in₁, . . . , inₖ sequentially, and the input at the current time frame is inₖ₊₁.

Let M= [symbol] V, INIT, Trans [symbol] be a hardware design. Let equal^{k}:INIT²×I^{k+1}×(I ∪ S ∪ C)→{true, false} be a function defined as equal_{M}^{k}(s₀¹, s₀², . . . , inₖ₊₁, var)≡val_{M}^{k}(s₀¹, in₁, . . . , inₖ₊₁, var)=val_{M}^{k}(s₀², in₁, . . . , inₖ₊₁, var) If we let [symbol] =(O₁, . . . , [symbol] )ε (IUSUC [symbol] denote the vector of outputs, then equal_{M}^{k}(s₀¹, s₀², in₁, . . . , inₖ₊₁, oⱼ) is true for any input sequence and any two initial states if and only if, the input sequence can not differentiate between the initial states based on the valuation of oⱼ. In many practical cases, a generalized notion of output equivalence is more suitable; each output is “guarded” by a valid bit, which determines whether the value on that output should necessarily be deterministic. In this paper, we assume, without loss of generality, that each output signal has a valid bit; an output signal without a valid bit can be described as an output signal with a valid bit set to the constant true (for this purpose, val (s, in, true)=true for any s ε s and in ε I). The following generalizes the definitions of value to valid-value which takes into account the valid bit (if invalid, value is assumed to be 0), and of valid-equal to be the analogue of equal. Let [symbol] V=(ov₁, . . . , o [symbol] )⊂(IUSUCU {true} [symbol] denote the vector of the valid bits, where ovᵢ is the valid bit of oᵢ.

Let valid—value_{M}^{k}:

INIT×I^{k+1}×(IUSUCU {true})×(IUSUCU)→{true, false}×R be define as follows:
valid-value_{M}^{k}(s₀, in₁, . . . , inₖ₊₁, valid, var)=(val_{M}^{k}(s₀, in₁, . . . , inₖ₊₁, valid), value);
where-value=val_{M}^{k}(s₀, in₁, . . . , inₖ₊₁, valid)? val_{M}^{k}(s₀, in₁, . . . , inₖ₊₁, var): 0
Let valid-equal_{M}^{k}: INIT²×I^{k+1}×(IUSUCU {true})×(IUSUC)→{true, false} be function such that
valid-equal_{M}^{k}(s₀¹, s₀², in₁, . . . , inₖ₊₁, valid var)=true if and only if

valid-value_{M}^{k}(s₀¹, s₀², in₁, . . . , inₖ₊₁, valid var)=valid-value_{M}^{k}(s₀², in₁, . . . , inₖ₊₁, valid var)

where the operator=defines equivalence classes for the set of function in INIT²×I^{k+1}×(IUSUCU {true})×(IUSUCU)→{true false}, i.e. it is a reflexive, symmetric, and transitive relation.
Definition 1. A hardware design M is valid, outputs consistent at (after) k₀, denoted by VOutput-Consistent-At (After) (M, k₀), if the following holds for k=k₀(∀k≧k₀):

∀j ε {1, . . . , n₀}, ∀s₀¹, s₀² ε INIT, ∀in₁, . . . , inₖ₊₁ ε I: valid-equale_{M}^{k}(s₀¹, s₀², in₁, . . . , inₖ₊₁, ovⱼ, oₖ)

### 3 EXAMPLES OF SELF EQUIVALENCE CRITERIA

In this section, we look at examples of implementing the criterion in Definition 1 using logic models that can be diagnosed via a hardware circuit or a computer simulating and proving the said criterion. The first example involves straightforward comparison of output values for the purpose, among others, of validating X behavior. The second example involves comparing output values while incorporating design information that qualify values. This latter example is illustrated through two applications, wherein the choice of qualifiers determines additional parameters in the given correctness criterion.

These criteria are characterized by simplicity and brevity of what the user of the system providers, as will be showcased in Section 5.

To define the various examples, we will specify the equivalence relation for the set of functions INIT²×I^{k+1}×(IUSUCU {true})×(IUSUCU)→{true false} in Definition 1. Given two functions F₁, F₂: I*→I*, the equivalence class partition the values such that two values belong to the same class if and only if valid-value_{M}^{|F}^{₂}^{(in)|}(s₀², F₂(in), valid, var) has an equal value to valid-value_{M}^{|F}^{₂}^{(in)|}(s₀², F₂(in), valid, var) for all possible input values, where in=in₁, . . . , inₖ₊₁, and |Fᵢ(in)| is the length of the inputs vector returned by Fᵢ(in). In other words, the result will be true if and only if starting from the initial state s₀¹, and apply the input sequence F₁(in), or starting from s₀² apply the input sequence F₂(in) con not be observed on the output var.

By varying the functions F₁ and F₂, the equivalence class is determined, and in turn the type of Equivalence Criterion is chosen.

### 3.1 Qualification Free Equivalence

The most simplified case is defined by choosing F₁=F₂=I (The identify function) in VOutput-Consistent-After (M, k₀), and ∀i: ovᵢ=true. This case represents qualification-free self equivalence. If VOutput-Consistent-After (M, k₀) is true under this case, the two copies of the design has no observable differences on the outputs at/starting at k₀, indicating that there are no X's on the output of the design for the given reset sequence, provided that inputs are also qualification free. Applications for this example are brought in the previous disclosure for this patent.

### 3.2 Qualified Equivalence

### 3.2.1 Qualify Outputs

If we let F₁=F₂=I, and allow ovᵢ to be any signal in the design, i.e. not always true, then this will represent the case in which the outputs are tested for differences under some conditions. Applications for this example are brought in the previous disclosure for this patent.

### 3.2.2 Qualify Outputs and Qualify Inputs by Allowing Xs

Some designs are supposed to sample part of their inputs only in a subset of the scenarios, for example, if the design has an input i and an input vᵢ such that vᵢ is a valid bit for i, or in other words v indicates when the value of vᵢ is valid, then changing the value of i when vᵢ is not active should not affect the outputs of the design. This feature can be easily tested using the self equivalence approach by letting the function F₂ replace i with an X when vᵢ is not active, and F₁=I.

### 3.2.3 Qualify Outputs and Qualify Inputs by Allowing Timing Differences

In this scenario we let the function F₂ provide a different input sequence that is supposed to give the same output as the original sequence. For example, given a design that takes an input i, and it is supposed to do nothing when i=NOP, then we will let F₁=I, and F₂(in₁, in₂ . . . , inₖ)=in₁, NOP, NOP, in₂, NOP, NOP in₃ . . . , NOP, NOP, inₖ. In other words F₂ gives the design more time to handle an input before getting the next one, while the expected final result should not be affected. In this scenario multiple kinds of control and optimization bugs can be exposed, such as bugs in pipelining, caching, queuing, X-related power optimizations, dynamically controlled power optimizations, and Parallelism in data fetching or processing or resource sharing.

### 4 LEVERAGING AUTOMATIC FORMULATIONS FOR HARDWARE DESIGN

The previous section described various examples of leveraging the correctness comparison in Definition 1, in formulating relations on the design elements. This section explains examples of leveraging those towards creating meaningful and tangible results.

### 4.1 In Simulation

The first utilization is applying drivers that push stimuli values on the inputs of the two copies of the design, and checking whether the equivalence holds. This is a direct application of the correctness criterion in verification using Simulation, also referred to as Functional Verification.

A simulator will process the design written in Verilog or C or any chip design or software design language, and will apply those values and calculate the value of the comparison over clock ticks or any other notion of time or progression. In this application, an existing verification environment that was previously written with or without user-defined assertions, can be leveraged to verify the new criteria given by Definition 1.

### 4.2 In Formal

The second utilization, which is related, is using exhaustive proof or analysis algorithms, to automatically compute drivers that violate the given criterion. This is a direct application of the correctness criterion in verification using Formal Verification. A formal tool will process the design written in Verilog or C or any chip design or software design language, and will compute value sequences over clock times or equivalent notion, that will violate the comparison, or prove that none exists.

### 4.3 In Property Generation

In the previous two examples, the criterion in Definition 1 is implicit in the comparison or the software representation in memory of the corresponding relations in the design. In a third utilization, the criterion is generated explicitly via an Assertion, which can be fed to a Simulation or Formal tools that perform the check independently. This allows the method to be used for automatic generation of Simulation assertions or Formal properties. While designers and engineers manually write initial assertions or properties and assess their coverage, said method can help automate this process for additional assertions/properties, or even the creation of those from scratch without having the designer or verification engineer seed the system with no initial properties/assertions at all.

### 4.4 In Improving Functional Coverage

In a fourth utilization, incrementally improving functional coverage is achieved and documented, with applying more and more sophisticated variations as given in sections 3.1 and 3.2.

Qualification-free Equivalence given in 3.1 represents the weakest, albeit useful, formulation of correctness, wherein design sample points are supposed to be deterministic and ×free.

Strongest functional coverage is achieved using the formulation in 3.2.1, in which the design outputs are consistent with the specifications (including documents) in terms of readiness of output values. A design that is not consistent with this will require further debug and analysis, and will obviously not meet stricter definitions of functional correctness.

To further strengthen the functional coverage, designers can apply the formulation in 3.2.2, in which inputs are allowed to have non-default qualifiers.

Significantly stronger coverage is achieved through the formulation 3.2.3. Designs passing this criterion, will be characterized by correct control logic for dealing with complex sequences. Such control logic may implement pipelining, caching, queueing, X-related power optimizations, parallelism, or other Reference Independent Optimizations (RIOs) used for improving power, area, and performance. The use of this criterion in software verification is also possible, for showing the parallelism produces the same result as a monolithic non-parallel system.

Note that in this fourth utilization, the result of one stage can be used in the following (or other) stage. For example, qualification can be passed through the next stage, after being vetted in the previous stage.

### 4.5 In a Comprehensive Methodology

The qualified design in Definition 1 represents a simplified version that strips away complex functionality related to the RIOs. It can therefore be used to relate the design to an independent reference. Therefore, rather than simulating the original design, or proving properties on it, or related it to the reference, verification can be done in two stages: using self-equivalence, and using equivalence between the qualified design and the independent reference. This separation enables two clear types of functional coverage to be assessed—functional coverage for RIOs, and functional coverage for basic functionality. It also allows leveraging automated abstraction methods [1] in the self equivalence stage, wherein datapath elements are identical in the two designs, and can be automatically and safely abstracted for the purpose of verifying RIOs. This leads to significant improvement to scalability of exhaustive proof-based verification.

### 5 ILLUSTRATIVE EXAMPLE

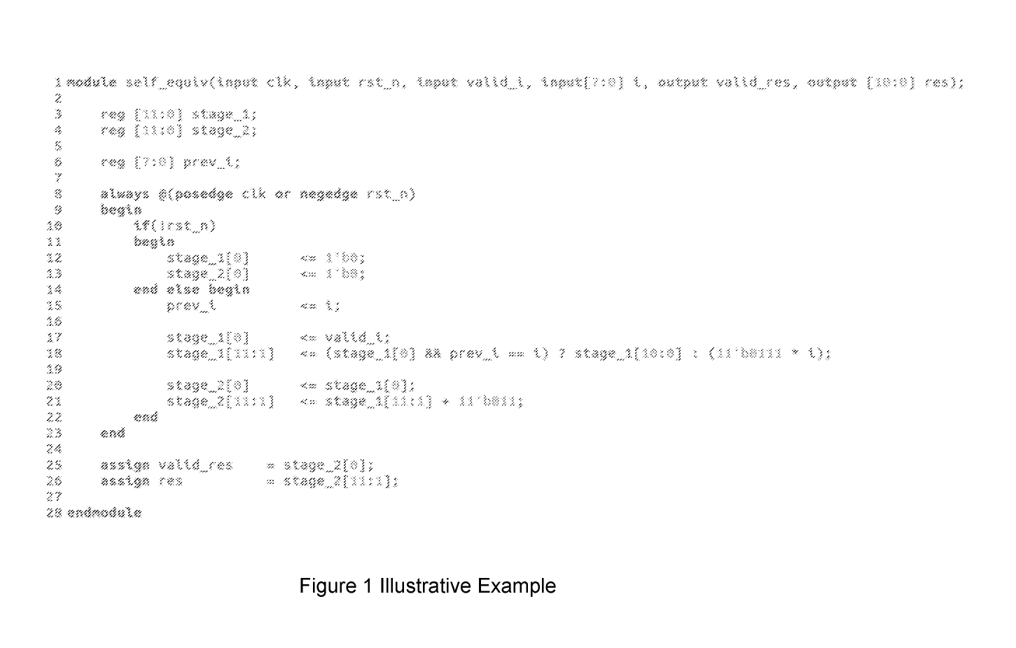

In this section we will illustrate the different self equivalence criteria on the simple design shown in FIG. 1. The design takes two inputs, valid_i and i, and returns two outputs valid_res and res, the input i is multiplied by 7 in the first stage, then a three is added to the result in the second stage before it goes to the output res. Note that at line 18 the design checks if the previous input prev_i was valid and it is equal to the current input i, if that is the case then the design is supposed to use the previous result instead, but there is a bug in the extract, stage_1[10:0] should be replaced with stage_1[11:1] to fix th bug. We will show how we can expose this bug by choosing the correct F₁ and F₂.

### 5.1 Qualification Free Equivalence

If we run without qualifiers, as described in subsection 3.1, a counter example will be produced, because stage_2[10:0] does not have a reset, thus the output res will have Xs. This is a false counterexample, because the output res should not be checked when valid_res is low.

### 5.2 Qualify Outputs

To prevent the previous false counterexample, we will use the criterion described in subsection 3.2.1, i.e. we will use the signal valid_res as the valid bit of the output res, and the proof will pass.

### 5.3 Qualify Outputs and Qualify Inputs by Allowing Xs

The value of the input i should not affect the outputs when valid_i is low, thus if we use the criterion described in subsection 3.2.2, i.e. we will let the function F₂ replace the input i with X when valid_i is low, and the proof will pass as well.

### 5.4 Qualify Outputs and Qualify Inputs by Allowing Timing Differences

The output of the design should not be affected if we insert an invalid input between every two in-puts, in other words, if we let F₁=I and F₂(in₁, in₂ . . . , inₖ)=in₁, NOP, in₂, NOP, in₃ . . . , NOP, inₖ, where inⱼ is the pair (iⱼ, valid_iⱼ), and NOP=(X; 1′b0). While setting the valid bit of the output res to valid_res as we did in the previous runs, the proof will fail with a real counter example that exposes the bug at line 18.

The rest of this section describes an exemplar general frame work, which enables duplicating the design, and modifying the input sequence to test pipelining, queues, and parallelism—three common control optimizations used for improving performance.

### 5.4.1 Example A—Pipelining

In this example, “Empty transactions”, equivalent to NOPs in processors, are added to create delays between transactions, in order to test pipelining and queues. Accordingly, the formulation takes into account (a) sampling at the correct time, and (b) incorporating the X qualifiers to allow meaningful results. While the user defines who the delays are inserted, this section describes how the sampling and incorporating of X qualifiers are done automatically, to allow the method to scale to large designs.

The general framework consists of two instantiations of the DUT (Deign Under Test), two Drivers, one for each instance, 2· [symbol] FIFOs, where [symbol] is the number of the DUT outputs, and inputs generator that generates inputs for the drivers and synchronize them (see FIG. 5.2).

Each driver is a design that takes as inputs all the outputs of the DUT in addition to a gated clock from the inputs generator, and its outputs are the inputs of the DUT, a valid bit ovⱼ for each output oⱼ of the DUT, and a special output called ready, which indicates that the driver is ready to take a new input from the inputs generator and send it, possibly with some modifications, to the DUT.

For each input of the DUT iⱼ, the inputs generator has a corresponding input iⱼ^{g} and a state-holding variable (register) sⱼ^{g}, the register sⱼ^{g} is not initialized and its value is updated to iⱼ^{g} at every cycle on which both drivers are ready. In some scenarios, some of the inputs should not affect the outputs of the DUT, or the results produced by it, for example, assume a design with one input called “in” and another input called “valid_in”, and assume that the design is supposed to use the value of “in” only when “valid_in” is true, in this case, every time “valid_in” is false, the valuation or “in” should not affect the design, thus one can assign the value X to the input “in”, formally for each input iⱼ the input generator holds a variable enXⱼ that enables X s on the input iⱼ, in other words, when Xenⱼ is true the input iⱼ is allowed to get different values on the two copies of the DUT, otherwise the two copies will get the same value from the input generator. Denote by iⱼ¹ the input iⱼ of the first driver, iⱼ¹ will be connected to a mux mⱼ¹ that is controlled by Xenⱼ, and outputs sⱼ^{g} when Xenⱼ is false and X when Xenⱼ is true, similarly iⱼ² of the second driver will be connected to the output of the mux mⱼ².

In addition, for each output oⱼ of the DUT, each driver holds a valid bit ovⱼ, when the valid bit in the first driver ovⱼ¹ is high, the output ovⱼ¹ will be inserted into the FIFO Fⱼ¹, similarly the second driver inserts 0ⱼ² to Fⱼ² when ovⱼ² is high. If both FIFOs are not empty the top of the first FIFO will be compared to the top of the second FIFO, and if they are not equal a counter example will be displayed to the user, otherwise the top will be removed from the two FIFOs.

Note that one driver might be much faster than the other, and a long FIFO will be needed to store all the outputs, to prevent such a scenario we use the ready flag of one driver as a gate for the second driver's clock, i.e. if one driver is ready and the other is not, the ready driver will be blocked. By using this technique the fast driver will be blocked until the slower driver is ready, thus it will not be able to produce too much results and a finite small FIFO will be enough.

As we saw in (sub-section 3.1 in [2]), here also the user may need to mark some of the registers as safe X to prune out false alarms, i.e. the user may want to assume that some of the registers are initialized to the same values in both copies of the DUT.

### 5.4.2 Other Examples of Optimizations

1. X-related power/area optimizations: Xs are used to optimize the power and the area of the chip, however, a wrong use of the Xs might affect the design correctness, and it can be easily—exposed by running a self equivalence using the algorithms described in (section 4 in [2]).
2. Caching: Caches do not affect the correctness of the design, they are used just to improve the performance. Thus a self equivalence between the design and itself can be ran where in one copy the cash is enabled and disabled in the other. And this will expose bugs in the cash if it is buggy.
3. Power Optimizations: Similarly to the cashing, the power optimizations, such as clock gating, should not affect the correctness of the design. Thus the design can be tested against itself with the power optimizations enabled in one copy and disabled in the other to expose bugs.
4. Parallelism: A design that handles K requests at every cycle, can be ran in a slower mode in which it handles a single request at every cycle and it is supposed to give the same results.
5. Baud Rate: in communication channels, the same data can be transmitted in different baud rates to expose bugs that affect one rate but not the other.

### REFERENCES

[1] Automatic Formal Verification of Control Logic in Hardware Designs, Z. Andraus, Ph. D. Dissertation, University of Michigan, Ann Arbor, April 2009.
[2] Sequential X Detection in Hardware Designs, Akram Baransi, Michael Zajac and Zaher Andraus, Reveal Design Auotomation, Inc., June 2012

What is claimed is:

1. A method for verification of hardware, comprising:
using self-equivalence to leverage automated abstractions where data path elements are identical in two designs; and,
using equivalence between a qualified design and an independent reference.
